(19) United States
(12) Patent Application Publication
(10) Pub. No.: US 2025/0306243 A1
(43) Pub. Date: Oct. 2, 2025

(54) System and Method for Determining Tropical Cyclone Intensity via the Moored Maximum Potential Intensity (MMPI) Framework

(71) Applicant: The Government of the United States of America, as represented by the Secretary of the Navy, Arlington, VA (US)

(72) Inventors: Robert K. Forney, New Orleans, LA (US); Adam Rydbeck, Pound Ridge, NY (US)

(73) Assignee: The Government of the United States of America, as represented by the Secretary of the Navy, Arlington, VA (US)

(21) Appl. No.: 19/091,098

(22) Filed: Mar. 26, 2025

Related U.S. Application Data
(60) Provisional application No. 63/570,326, filed on Mar. 27, 2024.

(51) Int. Cl. G01W 1/10; G06N 20/00; G06T 17/05

(52) U.S. Cl. CPC G01W 1/10; G06N 20/00; G06T 17/05

(57) ABSTRACT

A method of forecasting a maximum wind intensity associated with tropical cyclones, the method includes identifying a three-dimensional (3-D) field of ocean temperature and velocity, identifying a two-dimensional (2-D) field of sea surface temperature, tropopause temperature, surface level winds, incoming total solar radiation, and outgoing longwave radiation, determining a set of heat fluxes associated with ocean heat, and generating a 2-D map of the maximum potential intensity (MPI) based on (i) the set of heat fluxes and (ii) the first and second sets of data. The method may include training a machine learning model based on the first and second sets of data or the 2-D map of the MPI, and performing, based on the trained machine learning model and the 2-D map of the MPI, a mitigating activity corresponding to anticipated effects associated with the determined upper bound for tropical cyclone wind speed at a geographical location.

### CROSS-REFERENCE

This Application is a nonprovisional application of and claims the benefit of priority under 35 U.S.C. § 119 based on U.S. Provisional Patent Application No. 63/570,326 filed on Mar. 27, 2024. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #211918.

### TECHNICAL FIELD

The present disclosure is related to forecasting a maximum wind intensity, and more specifically to, but not limited to a system and method of determining tropical cyclone intensity via the Moored Maximum Potential Intensity (MMPI) framework and the implementation of that framework via an artificial intelligence machine learning model.

### BACKGROUND

The traditional tropical cyclone (TC) potential intensity (PI) concept was pioneered in 1986 by K. Emanuel. Emanuel's PI is based on the Carnot heat engine model, in which the ocean acts as a “hot plate” for atmospheric convection.

Emanuel's PI (EMPI) is traditionally calculated with coefficients of exchange for momentum and enthalpy, sea surface temperature (SST), outflow temperature, and moist static energy (MSE) disequilibrium. The latter is often parameterized in terms of latent and sensible heat flux (LH, SH) or convective available potential energy (CAPE).

While it is known that TCs are driven by the ocean, the ocean is only explicitly involved in calculating EMPI via SST. EMPI includes no subsurface information, such as ocean heat content (OHC) or dynamic controls of the ocean heat fluxes.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for a method of forecasting a maximum wind intensity associated with tropical cyclones. The method may include identifying, by a processing device, a first set of data comprising a three-dimensional (3-D) field of ocean temperature and velocity, wherein at least a portion of the first set of data is identified in situ and via one or more remote sensors. The method may include identifying, by the processing device, a second set of data comprising a two-dimensional (2-D) field of sea surface temperature, tropopause temperature, surface level winds, incoming total solar radiation, and outgoing longwave radiation wherein at least a portion of the second set of data is identified in situ and via one or more remote sensors. The method may include determining, by the processing device, based on one or more dynamic ocean processes, a set of heat fluxes associated with ocean heat, and generating, by the processing device, a 2-D map of the maximum potential intensity (MPI) based on (i) the set of heat fluxes and (ii) the first and second sets of data. The method may include training, by the processing device, a machine learning model based on the first set of data, the second set of data, or the 2-D map of the MPI, and performing, based on the trained machine learning model and the 2-D map of the MPI, a mitigating activity corresponding to anticipated effects associated with the determined upper bound for tropical cyclone wind speed at a geographical location.

### BRIEF DESCRIPTION OF THE DRAWINGS

FIG. 1 illustrates an example diagram illustrating a moored maximum potential intensity average and Emanuel's maximum potential intensity average, in accordance with one or more aspects described herein.

FIG. 2 illustrates an example diagram illustrating trends of moored maximum potential intensity average, Emanuel's maximum potential intensity, and regression, in accordance with one or more aspects described herein.

FIG. 3 illustrates an example diagram illustrating ocean heat content trends, in accordance with one or more aspects described herein.

FIG. 4 illustrates an example method in accordance with one or more disclosed aspects.

FIG. 5 illustrates an example computer system in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

One or more disclosed embodiments provide for a system and method to predict an upper bound for tropical cyclone (TC) wind speed (“potential intensity”, PI) at a location from measured or calculated environmental characteristics (e.g., ocean temperature and others). One or more disclosed embodiments provide for establishing the current or future risk of damaging TC activity.

One or more disclosed embodiments provide for adding new degrees of freedom to adjust based on OHC to increase skill—where this was not possible before (more variables involved, and 3D instead of 2D spatially).

One or more disclosed embodiments provide for a new way to determine the real TC PI that is typically overestimated by current methods (e.g., EMPI)—this includes the ability to tack on coefficients that scale PI based on new factors like stratification and atmospheric wind shear.

The disclosed framework provides for training artificial intelligence machine learning models to forecast PI operationally.

Maximum potential intensity (MPI) of tropical cyclones (TCs) is largely controlled by the moist static energy (MSE) disequilibrium, a quantity proportional to the net exchange of latent and sensible heat fluxes between the atmosphere and ocean. These fluxes can also be expressed as the residual internal energy, which is not stored in the ocean, locally transported away by ocean dynamics, or modulated by shortwave and longwave radiation. The MPI is reframed to include ocean processes such as ocean heat content (OHC) tendency, horizontal and vertical advections and diffusions, and net radiation. This yields a new “moored” MPI (MMPI) equation that provides insight into ocean dynamics contributing to observed spatial and temporal trends in MPI. Disclosed aspects provide for the trends in MMPI, OHC, and OHC Tendency from 1994 to 2020 to determine the ocean's role in explaining recent research suggesting that TCs are intensifying and moving closer to coasts.

Original EMPI is calculated from either CAPE or latent and sensible heat fluxes. The novel aspects described herein (Moored PI framework) determines TC PI using additional measures of the environment state (moves from 2D to 3D), adding degrees of freedom to adjust the PI to better match observations. A core difference is in how OHC is calculated and translated into heat fluxes that drive PI captured.

Furthermore, SST can be computed as a weighted average over a certain depth to increase accuracy/skill, in addition, outflow temperature may be calibrated based on atmospheric dynamics.

Additionally, it may be more realistic to include information about environmental characteristics that favor/disfavor intensification such as vertical shear of horizontal wind or salinity-driven ocean stratification. These factors are reasonably be accounted for in the novel Moored PI with further enhancements.

It is widely accepted that ocean heat content (OHC) is the driving force behind tropical cyclone (TC) intensification because the ocean acts as the “hot plate” driving atmospheric convection. Ocean temperatures above 26° C. support TC development and intensification. Despite the conceptual clarity and predictive capability that this model provides, aspects of TC behavior with respect to ocean conditions remain elusive. In order to better examine the role that the ocean plays in the modification of the maximum potential intensity (MPI) of TCs-a new equation for the MPI is derived, which explicitly incorporates oceanic energy fluxes as drivers of MPI. This novel MPI equation, called the “Moored Maximum Potential Intensity” (MMPI), is consistent with the commonly-used equation of Emanuel (1987) and differs in its capacity to diagnose the influence of dynamic and radiative ocean forcing on MPI. MMPI is shown to increase in general over 27 years with a spatial and temporal pattern that is partially explained by variations in the trend of OHC Tendency, but not apparent in trends in thermal disequilibrium between the ocean and atmosphere, nor in the OHC trend.

Disclosed embodiments of the Moored Maximum Potential Intensity framework (MMPI) include a coupled ocean-atmosphere predictor of the greatest intensity that a tropical cyclone can attain in a given environment.

One or more aspects provide for geophysical information that may be parameterized for operation and/or use of the MMPI, such as in one or more applications and/or AI/ML implementation described herein.

Disclosed aspects provide for three-dimensional (3-D) fields of ocean temperature and velocity. Disclosed aspects provide for two-dimensional (2-D) fields of sea surface temperature, tropopause temperature, surface level winds, incoming total solar radiation, and outgoing longwave radiation. Disclosed aspects provide for estimates of the drag coefficient between ocean and atmosphere, and the density of both air and seawater. Disclosed aspects can synthesize this information to produce a 2-D map of the maximum potential intensity (MPI) at every point where data is available.

Within the tropical cyclone (TC) literature, MPI is a key concept for predicting the severity of TCs. Previous Attempts: Traditionally, the formulation of MPI from Emanuel 1987 is utilized, making predictions chiefly from the sensible and latent heat fluxes. MPI is usually analyzed in a climatological context as opposed to forecasting particular storms. TC prediction for individual storms is typically conducted with numerical atmospheric models (often coupled with an ocean model) to attain the most comprehensive forecast. MPI serves as a general indicator of what severity storms could attain in a given region. This means that MPI is a lightweight framework for predicting TC intensity. MPI links TC intensity to the state of the environment via the concept of moist static energy disequilibrium (MSE)—this is typically parameterized as the sum of sensible and latent heat fluxes (SH and LH respectively). Deficiencies: The dependence of Emanuel's MPI (EMPI) on knowledge of SH and LH is both a strength and a weakness: it requires only two types of information, but since SH and LH are controlled by many dynamic factors, EMPI lacks the granularity to explain what factors are controlling MPI. Furthermore, SH and LH are highly sensitive to determination of atmospheric moisture content and surface temperature.

Tropical cyclone maximum potential intensity depends on sea surface temperature, outflow temperature, and radiative heat fluxes from the ocean to the atmosphere (Emanuel, 2007, hereafter E07). While SST and outflow temperature are important factors for determining TC MPI, trends in these variables alone cannot explain the global increase in TC intensity-therefore, the factors determining the oceanic radiative heat fluxes that drive TC intensification must be examined.

TCs arise from sufficiently strong perturbations in even a neutrally stable atmosphere (K. A. Emanuel, 1989); they derive their energy source almost solely from self-induced heat transfer from the ocean beneath the storm (Emanuel, 1986; Rotunno & Emanuel, 1987). TC tracks have been forecast quite well in recent years, especially since the trajectory of a TC largely depends on the ambient baroclinic steering flow in which it is embedded modified by the Coriolis force, potential vorticity dynamics, and horizontal and vertical shear (Chan, 2005). TC intensity forecasts have improved considerably as the understanding of TC physics advances [i.e., the reconciliation of dissipative heating and sensible heat flux ((Bister & Emanuel, 1998); Makarieva et al., 2019), use of coordinates that improve horizontal resolution in the eyewall (K. A. Emanuel, 1999), resolution of the question of precipitation effects (Makarieva et al., 2019), etc.], as well as with the advent of more powerful and widely available high-performance computing resources. While abundant questions remain about the origin and evolution of TCs (K. Emanuel, 2003), the maximum potential intensity (MPI) equation (Equation 1) has proven skillful in establishing the upper bound of wind speeds a TC may exhibit in given ocean-atmosphere environmental conditions (Tonkin et al., 2000) although exceptional cases in which observed TCs exceed MPI predictions exist (e.g., Bryan & Rotunno, 2009).

In the classical MPI relationship, shown by Equation 1 from Emanuel (Equation 5 in E07), Ck and CD are the coefficients of exchange for enthalpy and momentum respectively; Tsurface is the absolute temperature of the ocean surface; Toutflow is the absolute temperature at the level of the TC outflow, taken to be at the tropopause; k0*−k is the disequilibrium of moist static energy between the surface and the atmospheric boundary layer. However, additional variations of this MPI formulation are present throughout the TC literature (e.g., (Bister & Emanuel, 1998)). As shown in Equation 1, MPI is proportional to the Carnot parameter—a function of the ocean and tropopause temperatures—and the moist static energy (MSE) disequilibrium between the surface and boundary layer.

It should be emphasized that this equation characterizes the potential of a storm's intensity—in reality, as a TC approaches, its powerful thermodynamic and mechanical influence on the ocean and atmosphere alters their characteristics, and environmental features such as strong vertical wind shear (DeMaria, 1996) and ocean mixing (Glenn et al., 2016) can impact the ability of a TC to attain its potential intensity. Both of these considerations inform how the MPI equation should be interpreted: it is the intensity that a TC could attain if it were to appear in that environment without disturbing it on the approach, and spin up an interaction with the ocean. TCs rarely attain their MPI (Emanuel, 2000)—furthermore, TCs often weaken suddenly after attaining their lifetime greatest intensity, in contrast with modeled storms that tend to reach their peak intensity and maintain it (Emanuel, 2000). Modeled TCs will attain their MPI provided enough time and an absence of adverse environmental conditions in the ocean and atmosphere (Rotunno & Emanuel, 1987). It is also noteworthy that Equation 1 relates local power of turbulent dissipation in the boundary layer to local heat flux from the ocean via the Carnot parameter which pertains to a Carnot cycle as a whole—that is, the Carnot parameter is not a local characteristic (Makarieva et al., 2019). However, this is permissible because Emanuel's derivation of Equation 1 assumes gradient wind balance above the boundary layer.

One of the useful aspects of the MPI is its insensitivity to actual TC characteristics: analysis of the trend of MPI is not subject to problems inherent to the study of TC frequency, intensity, or spatial distribution. Therefore, it is helpful to examine the trend of MPI to make inferences about the trend of TC characteristics. When a large enough sample of TC events is considered, the distribution of intensities scales with the MPI (Emanuel, 2000). This is very convenient, since it implies that for a large sample of TCs, if the MPI changes by a certain percentage, then the actual TC intensity should change on average by the same amount (Emanuel's webpage, Anthropogenic Effects on Tropical Cyclone Activity, n.d.). This observation has motivated the analysis of trends in the factors that contribute to EMPI. An analysis of trends in global measures of MPI has been conducted using NCEP/NCAR Reanalysis (Bister & Emanuel, 2002a, 2002b), with a focus on SST, tropopause temperature, and convective available potential energy. The trend of the Carnot parameter (called thermodynamic efficiency here), net surface radiative forcing, and surface wind speed were analyzed to explain trends in MPI from 1950 to 2010 in E07. Their conclusion was that the long-term trend in MPI is determined by the radiative forcing and Carnot parameter factors (E07). While wind speed did not contribute to the long-term trend, increasing SST and decreasing outflow temperature contributed to more efficient conversion of heat to TC intensity (E07). However, changes in SST and outflow temperature alone cannot explain the increase in MPI in the decades at the end of their analysis, indicating that surface radiative heat fluxes are largely responsible for the observed intensification (E07). The evidence for control of MPI by heat fluxes such as those coming from the ocean motivates our present study.

Though the existing MPI equation is a staple of TC dynamical analyses, its capacity to explain the resultant MPI in terms of ocean-side factors has not been engaged to date. The introduction of ocean heat content (OHC), the advection and diffusion of OHC, and longwave and shortwave radiation is justified by the manner in which heat fluxes are incorporated in the derivation of Emanuel's MPI (EMPI) (Equation 1). Explicitly accounting for these factors in a “moored” MPI equation (MMPI) has the added benefit that analysis of the averages, climatology, and trends of these budget terms can be directly linked to MMPI. This makes it possible to anticipate future changes in the spatial and temporal patterns of MMPI while attributing the cause of these potential changes. This is especially useful when considering the feedback between TC activity and climate (Emanuel 2001). Therefore, the purpose of this study is to expand the traditional EMPI by explicitly including ocean-side terms, yielding the MMPI. An analysis of the trends in the oceanic global measures of MPI is a novel contribution to the literature made possible by the MMPI equation. Trends in the MMPI will be analyzed in the context of OHC to investigate the viability of OHC as a predictor of MPI similar to how SST is presently used, as well as the OHCT to investigate the role that a particular oceanic radiative heat flux term plays in determining MPI. The results are interpreted to infer the physical oceanographic mechanisms that are important to global changes in TC patterns.

Emanuel provides a derivation of the MPI from first principles or a simplified view in multiple papers (Emanuel, 1986, 1995, 2003; Emanuel 2007, hereafter E07; Bister & Emanuel, 1998), but fundamentally arriving at the equation (Equation 1) from a balance of local surface flux of turbulent dissipation and oceanic heat flux. Ocean processes are specifically implicated as a major contributor to the overall heat flux available to TCs for intensification (E07). However, the EMPI is frequently calculated with the sum of latent and sensible heat fluxes representing the whole of heat fluxes, which simplifies the calculation and has conceptual clarity but does not acknowledge specifically the role played by the other constituent heat fluxes.

$${V}_{p}^{2} = \frac{{C}_{k}}{{C}_{D}} \frac{{T}_{surface} - {T}_{outflow}}{{T}_{outflow}} ( {k}_{0}^{*} - k ) \qquad ( 1 )$$

Although the degree of thermodynamic disequilibrium in Equation 1 is generally regarded to be a function of sea surface temperature (SST) alone, the dependency of thermal disequilibrium on the state of the ocean-atmosphere system can be represented with greater complexity (E07). Considering the steady-state heat balance of the ocean mixed layer (Equation 2), the net flux of energy through the sea surface (left-hand side) is balanced by an ocean-side flux of energy into the mixed layer (E07).

$${C}_{k} ρ \vert V \vert ( {k}_{0}^{*} - k ) - F ↓ + F ↑ = {F}_{ocean} \qquad ( 2 )$$

In Equation 2 (Equation 6 in E07), ρ is the average air density near the surface; |V| is the average surface wind speed; F↑ is the net infrared radiative flux out of the ocean; F↓ is the net solar flux into the ocean; Focean is the net energy flux into the ocean mixed layer via oceanic processes. MSE disequilibrium (k0*−k) can be solved for in terms of radiative fluxes and oceanic heat fluxes.

By rearranging Equation 2 to isolate the disequilibrium of MSE, and substituting for the same in Equation 1, one obtains Equation 3 (Equation 7 in E07):

$${V}_{p}^{2} = \frac{{T}_{surface} - {T}_{outflow}}{{T}_{outflow}} \frac{F ↓ - F ↑ + {F}_{ocean}}{{C}_{D} ρ \vert V \vert} \qquad ( 3 )$$

Now MPI is in terms of heat fluxes, and the oceanic fluxes can be expanded to encompass mechanical and thermodynamic controls of OHC.

The strong apparent dependence of MPI on SST makes sense within the framework of Equation 3—both MPI and SST vary with a strong dependence on surface radiative flux and wind speed (E07). However, the explicit dependence of MPI on SST (Ts) is weak compared to the radiative fluxes in Equation 3. Considering Focean alone, the flux of energy from the ocean to the atmosphere depends to a great extent on OHC, which is defined here as in Equation 4.

$$OHC = 〈 {T}_{o} 〉 = {ρ}_{o} {C}_{o , p} {\int }_{H}^{surface} ( T - {T}_{reference} ) dz \qquad ( 4 )$$

Equation 4 considers the ocean heat content in excess of Treference, taken to be 26° C., because TCs intensify under such warm conditions; T is the absolute temperature of the ocean; ρo is the density of seawater; Co,p is the specific heat of seawater at constant pressure; the integral is evaluated vertically from the base of the layer whose temperature matches or exceeds 26° C. to the surface. Expanding the scope of Focean to include ocean processes of advection and diffusion of OHC, and adding penetrative shortwave radiation to F↓, yields Equation 5—the Moored MPI—where

$${{V}_{p}^{2}}_{MMPI} = {\frac{1}{{C}_{D} ρ \vert V \vert}}_{{MPI}_{coefficient}} \frac{{T}_{s} - {T}_{out}}{{{T}_{out}}_{{Carnot}_{parameter}}} ( [ - {\frac{\partial ( {T}_{o} )}{\partial t}}_{{OHC}_{Tendency}} + {( {v}_{ok} \cdot ∇ {T}_{o} )}_{{{Horizontal}_{advection}}_{of OHC}} + {( {w}_{o} \frac{\partial {T}_{o}}{\partial z} )}_{{{Vertical}_{advection}}_{of OHC}} + {( {A}_{h} {∇}^{2} {T}_{o} )}_{{{Horizontal}_{diffusion}}_{of OHC}} + ( \frac{1}{H} {{A}_{z} \frac{\partial {T}_{o}}{\partial z}}_{{{Vertical}_{diffusion}}_{of OHC}} ) ] - {F ↑ + F ↓}_{{{Net longwave}_{and shortwave}}_{radiation}} ) \qquad ( 5 )$$

F↓=SWsurface−SW|H and F↑=LWsurface−LWout. Angle brackets indicate a vertically depth-integrated quantity. Incorporation of the OHC and MSE disequilibrium in this fashion is similar to the approach taken by Rydbeck et al. (2023), and the “moored” epitaph, adopted from Rydbeck, represents the connections between MSE sources and sinks and subsurface ocean processes (Rydbeck et al., 2023). The calculation of MMPI demands the incorporation of several ocean and atmosphere physical data variables: sea surface temperature (SST), tropopause temperature (Tout), surface wind speed (V), surface longwave radiation (LWsurface or SLWR), outgoing longwave radiation (LWout or TLWR), surface shortwave radiation (SWsurface or SSWR), penetrative shortwave radiation (SW|H or SSWR_pen), the ocean vertical velocity profile decomposed into zonal, meridional, and vertical components (vo,h for the horizontal components and wo for the vertical), and the ocean temperature profile decomposed into zonal, meridional, and vertical components (To). The drag coefficient (CD), density of seawater (p), and horizontal and vertical diffusivity (Ah and Az) are considered to be constant.

Like the EMPI, all of the fluxes that contribute to the heat available for TC intensification are scaled by a factor proportional to temperature disequilibrium between the ocean surface and the tropopause and has an inverse relationship with surface wind speed. Unlike the EMPI, which considers all contributors to the heat budget to be lumped together in latent and sensible heat fluxes, the MMPI explicitly accounts for dynamic ocean processes of advection and diffusion, penetrative shortwave radiation, and net shortwave and longwave radiation. The sum of these heat fluxes equals the sum of the latent and sensible heat fluxes: consequently, EMPI and MMPI make identical predictions from different information. The explicit nature of the MMPI equation is useful for diagnosing the controls of MPI.

It should be noted that the MMPI can provide additional improvements over the EMPI by replacing the SST with a “fully mixed SST” or “hybrid mixed SST”. The motivation for this arises from the observation that EMPI tends to overestimate the intensity that real TCs attain. A possible physical explanation for this is that the SST of the environment prior to TC arrival will necessarily be perturbed by the approach of the TC—presumably it will be reduced by mixing due to strong TC winds. Additionally, OHC can be decoupled from TC intensity in cool or shallow waters (Price 2009). By combining the ocean dynamics, many terms of which depend on OHC, with either a temperature that the upper 100 m would have if fully mixed (“fully mixed SST”) or an average of the true SST with the fully mixed SST (“hybrid mixed SST”), both the importance of OHC and SST can be incorporated, with the expected effect of reducing predictions of MPI to more realistic levels. This modification would not be possible with EMPI.

Another potential modification of the MMPI is a “MMPI integrated risk factor”, an indicator of how intense a TC would be on average for a given starting point for an existing storm and a landfall location. This metric would in its most basic form be an integration of the MMPI calculated along various hypothetical tracks weighted by the probability of occurrence for each track.

### Oceanic and Atmospheric Data

The ocean reanalysis GLORYS12 and the atmosphere reanalysis provide the needed variables. GLORYS12 is a global eddy-resolving physical ocean and sea ice analysis having 1/12×1/12° horizontal resolution and covering the period 1993-present (the period 1994-2020 is used) (Jean-Michel et al., 2021). ERA5 has a horizontal resolution of 0.25×0.25° and covers the time period 1950-present (the period 1994-2020 is used) (Hersbach et al., 2020). It is important to characterize the error correction of reanalysis products in light of known errors and biases in the observations that are ingested by such models [i.e., ocean temperatures (Abraham et al., 2013)]; while GLORYS12 does have a stronger-than-observed warming trend, it is still regarded as state-of-the-art for climate applications (Jean-Michel et al., 2021). The GLORYS12 and ERA5 reanalyses are regridded bilinearly upscale onto a common 0.5°×0.5° grid.

### Statistical Analysis of MPI and Budget Terms

In order to examine the trend of OHC and MPI more clearly, the seasonal cycle and El Niño-Southern Oscillation (ENSO) were removed. ENSO is associated with a strong redistribution of OHC, either through a direct influence as in the Pacific Ocean (Wyrtki, 1975) or via teleconnections globally (C. Wang, 2018). Global cooling of the ocean and atmosphere occurs during and after El Niño events (Cheng et al., 2019). While the exact mechanisms [be it the “delayed oscillator”, “recharge-discharge oscillator”, “western Pacific oscillator”, or “advective-reflective” paradigm (C. Wang, 2018)] and timescales by which ENSO impacts OHC are not fully understood, the ENSO dependence of OHC can nonetheless be removed using its statistical relationship with the Oceanic Niño Index 3.4 (ONI). While the ONI is calculated based on a lagged climatology and therefore possesses a bias towards El Niño conditions due to a warming climate (Van Oldenborgh et al., 2021), other ways of quantifying ENSO also exist with their own caveats. Another consideration is that the effect of ENSO on the data variables herein could have a nonlinear component; however, for the sake of clarity, only linear correlations with ENSO were considered with this approach. Analysis of means and trends are performed on the residuals of the data variables after the removal of a seasonal signal and an ENSO component. The seasonal cycle was computed as the mean by day of the year (i.e., the mean of January 31 is removed from every data point falling on January 01). The ENSO component was calculated from the linear regression of each data variable against the ONI. The removal of these signals reduces the potential that explainable cycles could contaminate the averages and long-term trends while also facilitating comparison between boreal and austral TC seasons. Points having fewer than four contributing data values were excluded from the calculation of long-term trends.

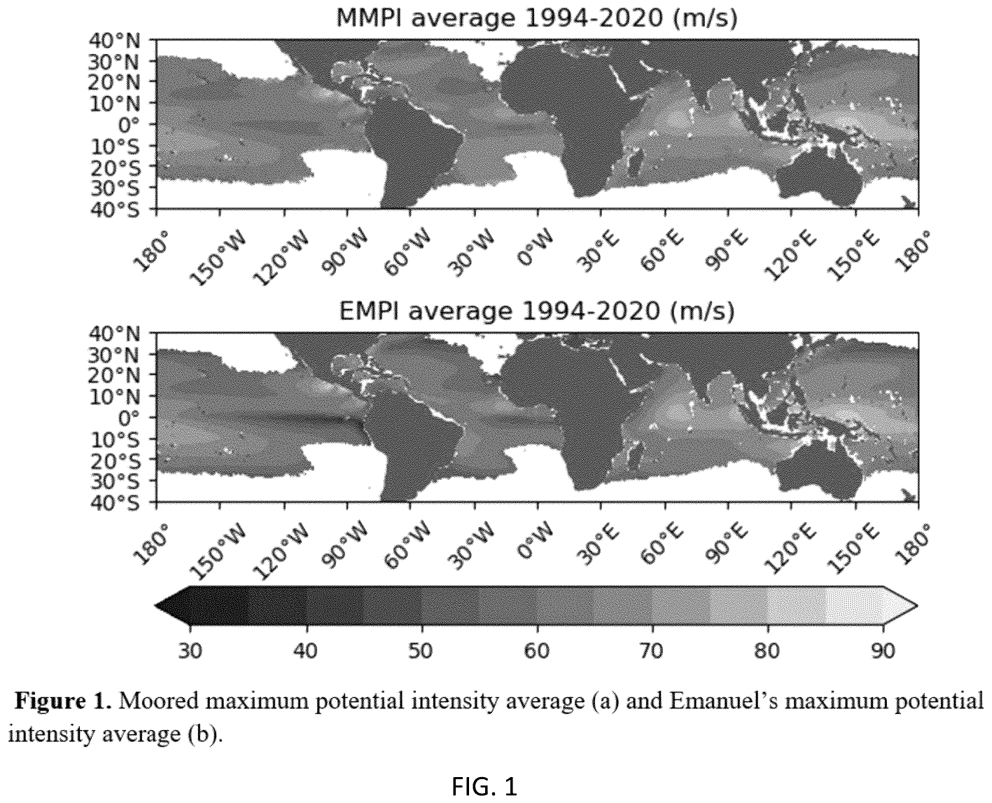

The MMPI (FIG. 1a) and EMPI (FIG. 1b) have nearly identical averages, with any discrepancies related to the MMPI's OHC requirement which prohibits MPI calculation in settings where ocean temperatures do not exceed 26° C. and thus yields fewer data points. Examination of particular dates (not shown) confirms that the MMPI agrees with EMPI and is a viable alternative method of calculating MPI. Both methods (collectively “MPI”) attain maxima in the W. Equatorial Pacific, central Indian Ocean, in the Atlantic main formation region, and both east and west of Mexico. MPI decreases towards the poles; there is also a minimum in the E. Equatorial Pacific on the equator, an area known for persistent upwelling as part of the global thermohaline circulation. MPI is typically higher near western boundary currents, which transport warm water from the equator towards the poles, than near eastern boundary currents, which do the opposite.

The MMPI, which accounts for ocean dynamics, agrees closely with the established EMPI but does have some differences in the average, especially in the E. Equatorial Pacific and northern Atlantic main formation region. These regions of difference also have higher uncertainty in general due to fewer contributing points for MMPI calculation. Grid points at higher latitudes typically have fewer instances of OHC exceeding 26° C. because ocean temperatures at the mid-latitudes and higher are strongly influenced by the seasonal cycle, and while the seasonal mean is removed from these data, the seasonal impact on spatial extent of OHC remains. This is not a problem for calculating EMPI because latent and sensible heat fluxes can be determined without considering OHC—however, the physical significance of MPI predicted in the absence of ocean conditions supporting TC intensification is dubious. The average of EMPI is presented only where MMPI exists for ease of comparison. While the MPI is most relevant during hurricane season—1 June to 30 November in the North Atlantic basin, with 97% of TC activity occurring in this date range (Hurricane Research Division 2015)—MPI is nevertheless defined throughout the year. In regions where ocean temperatures do not reach or exceed the threshold for TC intensification, OHC and hence MPI can be considered nonexistent. It may be the case that in future warming climate scenarios MPI will be relevant outside of the time when TCs normally occur since there is already some evidence that the TC season is expanding (Kossin 2008).

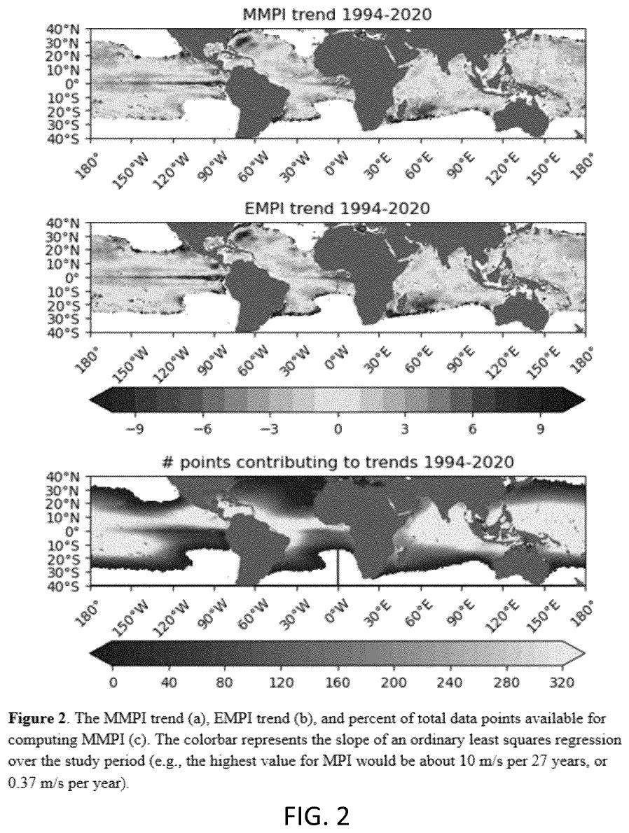

Both forms of MPI show an overall intensifying trend during the study period 1994-2020, but some regions, notably parts of the Atlantic main formation region, exhibit a weakening trend. The intensifying trend seems to agree with evidence that TCs are intensifying on average (Holland & Bruyère, 2014). The strongest intensification is occurring at a rate of ˜0.37 m/s per year along the world's western boundary currents, in the Mediterranean Sea, and off the western coast of Central America. The strong intensification along the western boundary currents may support observations that TCs are moving closer to coasts (S. Wang & Toumi, 2021), since TCs cannot persist in regions that do not support their intensity, and the coastal regions along western boundaries are increasingly TC-favorable. Weakening trends are generally less intense, on the order of ˜0.37 m/s per year in the equatorial Pacific Ocean, ˜0.22 m/s per year in the Atlantic Ocean eastern boundary, and ˜0.03 m/s per year in scattered regions of the Indian Ocean and western Pacific Ocean. EMPI is more conservative in its evaluation of the trends than EMPI, which is attributable to some degree of uncertainty in the calculation of the trend for MMPI (FIG. 2c); their agreement is exact in regions of higher confidence.

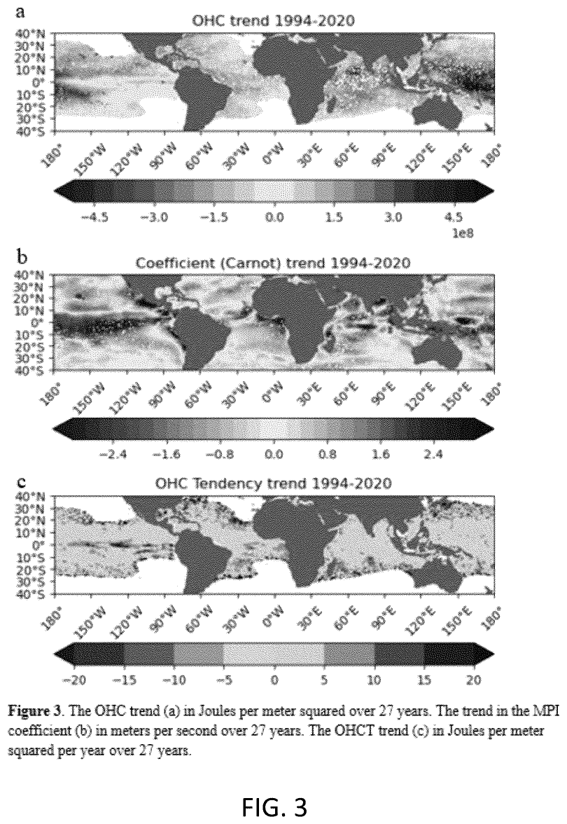

Logically, variations and trends in MPI should be explained almost entirely by examining the OHC itself—after all, MPI has historically been regarded as controlled by SST, which is reflective to a great extent of the OHC beneath the surface. However, a comparison of the OHC trend (FIG. 3a) with the MPI trend challenges this intuitive notion. OHC is increasing almost everywhere—the only notable region of decrease is the E. Equatorial Pacific upwelling zone, and regions of near-zero trend are small and infrequent. In the areas of greatest increasing MPI trend, the western boundary currents, the OHC trend is positive but hardly more intense than the adjacent regions. The decreasing MPI trend in the E. Equatorial Pacific matches the decreasing trend in OHC, but the decreasing MPI trend in the W. Equatorial Pacific is contradictory to the peak intensity of OHC trend that is present there. The disconnect between OHC trend and MPI trend is can be explained even without considering ocean dynamics: the EMPI is governed by latent and sensible heat fluxes, which do correspond to the heat flux available from OHC, but those fluxes are modified by the temperature differential between the ocean and tropopause as well as the surface level winds. This is also the case for MMPI, suggesting that trends in both EMPI and MMPI might be explained by trends in their common coefficient, which incorporates the SST, tropopause temperature, and surface wind speed (see Equations 3 and 5).

The MPI coefficient increases with increasing disequilibrium between the ocean and atmosphere, and grows smaller with increasing wind speed. Since wind speed has no long-term trend (not shown, see Emanuel 2000), the trend in this coefficient (FIG. 3b) is a function of trends in SST and tropopause temperature. There is a decreasing trend (i.e., the thermal disequilibrium is decreasing) across the equatorial oceans with the exception of the Indian Ocean, which has a strong positive trend in many places. This matches the sign of trends in MPI across the equator, but perhaps does not correspond well in magnitude. The trend in MPI along the equator is generally weak except for the decreasing trend in the E. Equatorial Pacific, whereas the trends in the MPI coefficient along the equator are among the strongest worldwide. In areas of strong MPI trend, such as over the Gulf Stream and Kuroshio Current, the coefficient's trend is weak. Additionally, the coefficient has a weak negative trend, which is associated with weakening MPI since TC intensity increases with greater disequilibrium. The extent of the decreasing trend in the E. Equatorial Pacific is much greater than the extent of the same trend in the MPI, which has some spatial complexity with areas of increase just off the equator adjacent to the equatorial decreasing trend.

The time tendency of OHC (OHCT) can be thought of as the storage of heat in the ocean, with a positive value corresponding to increasing storage or flux from the atmosphere to the ocean, and vice versa (FIG. 3c). The intuitive meaning of a negative trend, therefore, is an increasing availability of stored OHC to TCs for intensification. An alternative way in which OHCT could have a negative trend is if OHC accumulation were decreasing over time, however, the trend in OHC suggests that this is almost never the case. The OHCT is distinct from the trend in OHC: OHCT is calculated as the divided difference of OHC from month to month and reflects the “acceleration of OHC” or “OHC storage” on that timescale, whereas the OHC trend reflects the long-term change in OHC over the study time period. Positive values of OHCT reflect increasing storage of OHC in the ocean, and negative values reflect the opposite. Trends in OHCT reflect the long-term change in OHC storage, with positive values indicating increasing storage (decreasing availability to the atmosphere) and negative values reflecting decreasing storage (increasing availability to the atmosphere). Strong negative trends are apparent east of the Gulf Stream and south of the Kuroshio Current where increasing MPI trends exist. Near the equator, trends are weakly positive or negative except near the E. Equatorial upwelling zone, where the sign is not consistent, but the magnitude is large. Strong positive trends occur near the Atlantic main formation region, collocated with negative trends in MPI. The regions in which OHCT attains a strong negative value suggest, when combined with the notion that OHC is increasing in general, that OHC is transferring from ocean storage to the atmosphere in those regions. However, areas of negative OHCT trends are typically adjacent to regions of positive OHCT trends—an indicator that there is an interplay between OHCT and the advection terms of the MMPI.

### Discussion

The Moored MPI equation provides conceptual clarity for the relationship between MPI and the ocean state relative to Emanuel's MPI, while producing near-identical predictions of tropical cyclone potential intensity. Uncertainty in the calculation of MMPI is introduced by the spatiotemporal variability of the OHC, but on the other hand, MMPI makes no predictions of MPI in regions where it is not physically feasible for the ocean to support TC activity (e.g., MPI is undefined where the ocean is not at least 26° C. and TCs weaken rapidly). By demonstrating the equivalence of the heat fluxes used in the EMPI and the MMPI equations, the MMPI budget terms can now be presented as possible controls of MPI.

The OHC trend suggests that OHC is increasing almost everywhere—which one would naively expect to lead to widespread increase in MPI. However, the areas of greatest increase are not collocated with areas of greatest positive MPI trends, and regions of decreasing MPI collocated with increasing OHC cast doubt on the notion of a simple relationship between OHC and MPI. This is logical: an increase in OHC or even simply SST is expected to have a complex impact on TC characteristics due to the nuanced feedback between the ocean and atmosphere. For instance, if heat flux from the ocean to the atmosphere were to increase due to increasing OHC or SST, this could be expected to invigorate atmospheric circulation, resulting in a greater rate of tropical cyclogenesis as well as greater availability of heat for TC intensification. On the other hand, invigorated atmospheric circulation would lead to greater vertical shear of horizontal wind, hindering TC formation and intensification. Another critical factor for examining increase in OHC or SST is the ocean dynamics element: if OHC were to increase, it may mean an increase in heat fluxes within the ocean near the OHC anomaly via advection and diffusion rather than simply becoming available to the atmosphere immediately. Through this lens, the importance of accounting for ocean dynamics in the context of MPI is clarified. Further investigation of the oceanic influences on MMPI is required to fully account for what OHC is available to TCs for intensification.

The MPI coefficient, a function chiefly of sea surface temperature and tropopause temperature, was not as clearly linked to MPI trends. The MPI coefficient trend is primarily driven by the disequilibrium between the SST and tropopause temperature, since surface level wind lacks a long-term trend. If this disequilibrium is considered alone in the form of the Carnot parameter, disclosed aspects provide for the efficiency of the transfer of heat from the ocean to the tropical cyclone.

As a measure of thermodynamic efficiency, the Carnot parameter impacts the magnitude of any heat flux that contributes to MPI. As a result, the Carnot parameter must be treated differently from the heat fluxes—it alone cannot control MPI, and there must be a source of heat. It is possible to have a negative trend in the MPI coefficient which includes the Carnot parameter while having an increasing trend in MPI due to the rise in the heat fluxes that the coefficient modifies.

The trend in MMPI reflected recent research suggesting that TCs are intensifying, attaining high values in the western boundary current regions close to populous coastal regions. Based on the similar trend in OHCT, it is possible that OHCT is a factor driving this intensification. The trend in ocean heat content tendency is shown to correspond well in some areas to the trend in MPI, but does not explain all of the spatial variation. In particular, the proximity of strong negative and strong positive OHCT trends suggests that other budget terms such as horizontal and vertical advection of OHC must be examined in the same way to further explore oceanic controls of MPI. For instance, if the Gulf Stream were to move eastward, it would manifest a signal not only in zonal advection of OHC, but also in the OHCT, with OHCT becoming increasingly negative to the east and increasingly positive to the west. The more nuanced connection between OHCT and MMPI than between the MPI coefficient or the OHC shows promise for the hypothesis that OHCT is one of the drivers of MPI. Further analysis is required to ascertain whether or not the magnitude of the OHCT trend is sufficient to explain the MPI trend, and what effect the other MPI budget terms have on the MPI trend.

MMPI differs from EMPI in its parameterization of MSE: rather than determining SH and LH, MMPI uses the sum of ocean dynamic factors and radiative heating factors that impact MSE. This permits MPI to be calculated from measurements or simulations of the marine environment (including the subsurface). This implies:

1. Less dependence upon SH and LH which may be uncertain or unavailable
2. Utility for coupled ocean-atmosphere models that possess subsurface information
3. Elucidates how MPI can change with respect to a particular ocean dynamics parameter over any timescale (including climate)

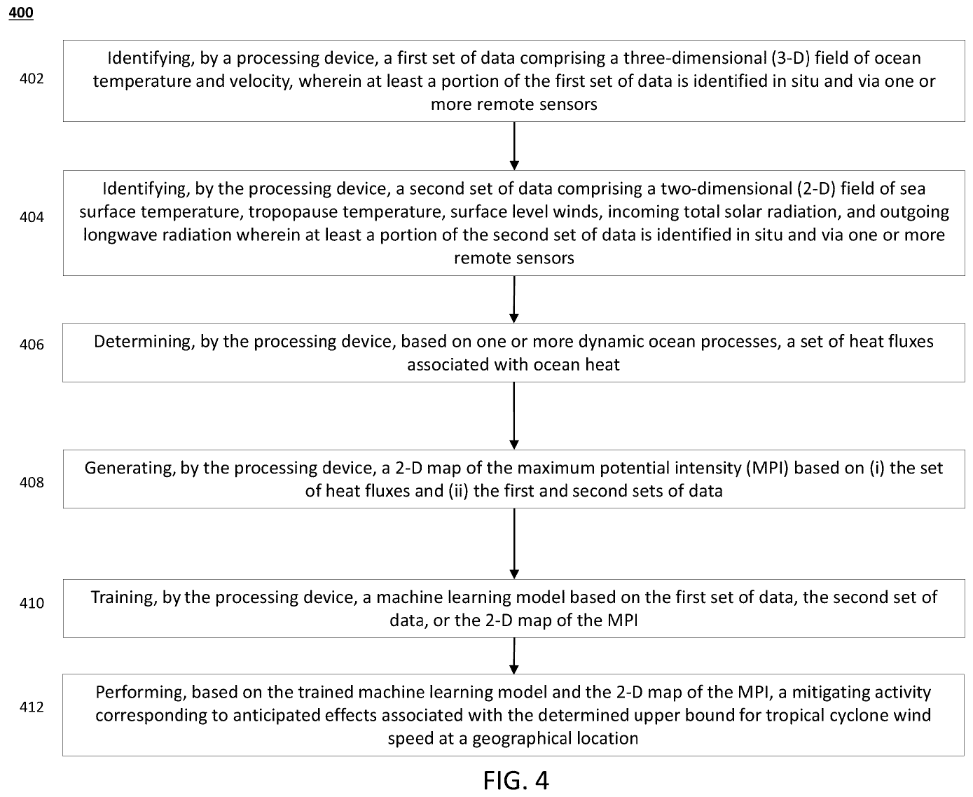

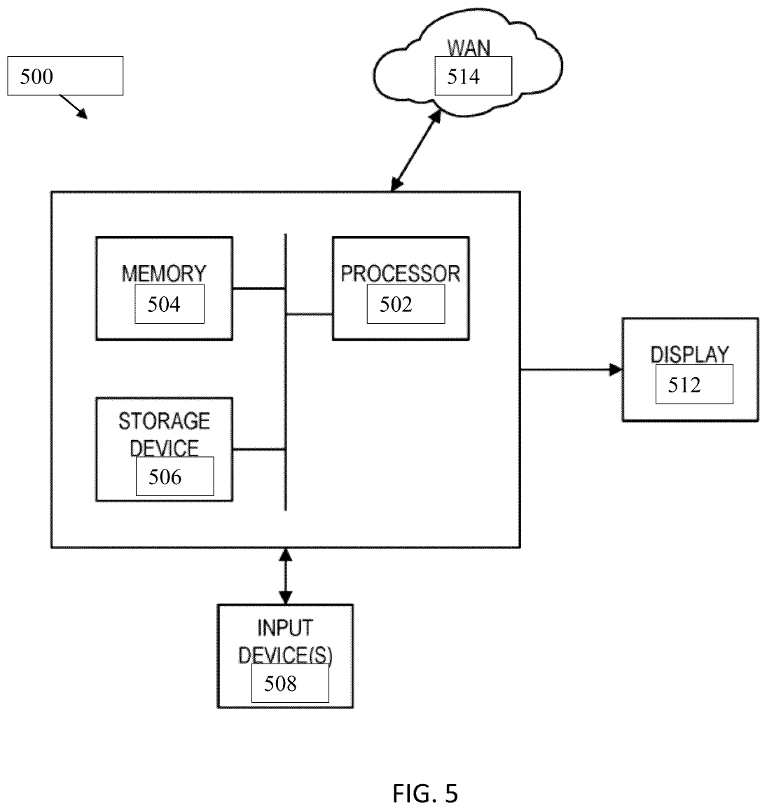

FIG. 4 illustrates an example method 400, in accordance with one or more disclosed aspects. For example, method 400 may be a method of forecasting a maximum wind intensity associated with tropical cyclones. Step 402 may include identifying, by a processing device, a first set of data comprising a three-dimensional (3-D) field of ocean temperature and velocity, wherein at least a portion of the first set of data is identified in situ and via one or more remote sensors. Step 404 may include identifying, by the processing device, a second set of data comprising a two-dimensional (2-D) field of sea surface temperature, tropopause temperature, surface level winds, incoming total solar radiation, and outgoing longwave radiation wherein at least a portion of the second set of data is identified in situ and via one or more remote sensors. Step 406 may include determining, by the processing device, based on one or more dynamic ocean processes, a set of heat fluxes associated with ocean heat. Step 408 may include generating, by the processing device, a 2-D map of the maximum potential intensity (MPI) based on (i) the set of heat fluxes and (ii) the first and second sets of data. Step 410 may include training, by the processing device, a machine learning model based on the first set of data, the second set of data, or the 2-D map of the MPI. Step 412 may include performing, based on the trained machine learning model and the 2-D map of the MPI, a mitigating activity corresponding to anticipated effects associated with the determined upper bound for tropical cyclone wind speed at a geographical location. One or more steps may be repeated, added, modified, and/or excluded. One or more steps may be performed by a computer, computing device, processing device, or the like, such as the one described herein and shown in FIG. 5.

According to some aspects, one or more disclosed embodiments may have one or more specific applications. For example, disclosed embodiments may be useful for operations and planning, such as for safety, the public, private entities, the military, and/or the like. In some cases, disclosed embodiments can provide a competitive advantage in correctly anticipating the danger of developing TCs in the battlespace environment and for homeland security. In some cases, disclosed aspects may be used for search & rescue, for safety of navigation, for military situational awareness, for implementing and/or developing a mission route plan associated with operating a vehicle, aircraft, vessel, and/or the like. In some cases, one or more disclosed aspects may be used to facilitate a strategic operation, which can include a defensive tactical operation or naval operation. According to some aspects, disclosed embodiments provide for the ability to incorporate the Moored PI into a TC forecast model. In some cases, the Moored PI may be the cornerstone of a suite of holistic forecasting methods (e.g., polar lows, marine heat waves, etc.).

According to some aspects, disclosed embodiments provide for training artificial intelligence machine learning models to, in one example, perform and/or assist in performing a mitigating activity, including but not limited to learning patterns of input data or PI, representing input data or PI, forecasting input data or PI, labeling features of maps of data or PI, generating input to calculate PI, generating estimates of PI where sufficient data is lacking, deriving other extreme weather metrics from input data or PI, and/or the like. Tropical cyclone intensity forecasting both for particular storms and for storms in future climate scenarios has proven problematic. Even with greatly improved theoretical understanding of TCs and more advanced numerical ocean-atmosphere modeling techniques, the uncertainty in estimates of intensity has remained substantial. When a TC is approaching the US coast for example, local government often vacillates about whether to issue an evacuation order or not, even with forecast information. False alarms are costly, but insufficient emergency response before a TC can lead to heavy casualties. Therefore, many companies and government agencies are invested in having a new method of predicting TC intensity to deploy alongside existing methods. For instance, the US National Oceanographic and Atmospheric Administration (NOAA) will continue to forecast particular storms using numerical atmospheric models forced by oceanic boundary conditions or fully coupled to an ocean model; however, such models diminish in predictive capability as forecast time is extended, so an assessment of the upper bound for TC intensity far in advance is useful. Since NOAA is already simulating the ocean-atmosphere environment for the forecasts, it is not a major logistical hurdle to use the same simulations to forecast MMPI. The advantage is an early warning about how severe TCs can be. MMPI also has the capability to forecast MPI in future climate scenarios, which can have economic implications, such as futures trading, insurance rates/market, etc.

One or more aspects described herein may be implemented on virtually any type of computer regardless of the platform being used. For example, as shown in FIG. 5, a computer system 500 includes a processor 502, associated memory 504, a storage device 506, and numerous other elements and functionalities typical of today's computers (not shown). The computer 500 may also include input means 508, such as a keyboard and a mouse, and output means 512, such as a monitor or LED. The computer system 500 may be connected to a local may be a network (LAN) or a wide may be a network (e.g., the Internet) 514 via a network interface connection (not shown). Those skilled in the art will appreciate that these input and output means may take other forms.

Further, those skilled in the art will appreciate that one or more elements of the aforementioned computer system 500 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for forecasting a maximum wind intensity have been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

What is claimed is:

1. A method of forecasting a maximum wind intensity associated with tropical cyclones, comprising:
identifying, by a processing device, a first set of data comprising a three-dimensional (3-D) field of ocean temperature and velocity, wherein at least a portion of the first set of data is identified in situ and via one or more remote sensors;
identifying, by the processing device, a second set of data comprising a two-dimensional (2-D) field of sea surface temperature, tropopause temperature, surface level winds, incoming total solar radiation, and outgoing longwave radiation wherein at least a portion of the second set of data is identified in situ and via one or more remote sensors;
determining, by the processing device, based on one or more dynamic ocean processes, a set of heat fluxes associated with ocean heat;
generating, by the processing device, a 2-D map of the maximum potential intensity (MPI) based on (i) the set of heat fluxes and (ii) the first and second sets of data;
training, by the processing device, a machine learning model based on the first set of data, the second set of data, or the 2-D map of the MPI; and
performing, based on the trained machine learning model and the 2-D map of the MPI, a mitigating activity corresponding to anticipated effects associated with the determined upper bound for tropical cyclone wind speed at a geographical location.

2. The method of claim 1, wherein the training is based on the 2-D map of the MPI, the method further comprising:
determining, based on the generated 2-D map of the MPI, an upper bound for tropical cyclone wind speed at a geographical location,
wherein the training further comprises training the machine learning model based on the determined upper bound.

3. The method of claim 2, wherein the generated 2-D map of the MPI is generated based on the set of heat fluxes that are based on ocean heat content that is greater than or equal to a reference temperature.

4. The method of claim 3, wherein the reference temperature is 26 degrees C.

5. The method of claim 3, wherein determining the upper bound comprises evaluating the generated 2-D map vertically from a base of the layer of seawater having a temperature that is greater than or equal to the reference temperature to an air-seawater surface interface.

6. The method of claim 1, wherein the one or more dynamic ocean processes comprise ocean heat content.

7. The method of claim 6, wherein the set of heat fluxes comprises latent and sensible heat fluxes.

8. The method of claim 6, wherein the set of heat fluxes is based on advection and diffusion, penetrative shortwave radiation, and net shortwave and longwave radiation.

9. The method of claim 1, wherein the 2-D map is generated for every point where data available in the first and second sets of data.

10. The method of claim 1, wherein generating the 2-D map of the MPI is further based on one or more oceanic fluxes encompassing mechanical and thermodynamic controls of ocean heat content.

11. The method of claim 1, wherein performing the mitigating activity comprises establishing the current risk of damaging tropical cyclone activity.

12. The method of claim 1, wherein performing the mitigating activity comprises establishing a future risk of damaging tropical cyclone activity.

13. The method of claim 1, wherein performing the mitigating activity comprises determining an indicator of intensity associated with a tropical cyclone for a given starting location for an existing tropical cyclone and a projected landfall location.

14. The method of claim 13, wherein the indicator is based on an evaluation of the 2-D map of the MPI calculated along one or more tracks weighted by a probability of occurrence for each track.

15. The method of claim 1, wherein performing the mitigating activity comprises performing a water-based operation.

16. The method of claim 1, wherein performing the mitigating activity comprises determining an indication of intensity of tropical cyclones for a hurricane season.

17. The method of claim 1, wherein the one or more remote sensors comprises at least one of a water-based craft, a buoy, a satellite, or a radar device.

18. A non-transitory computer-readable medium comprising computer code that, when executed by the processing device, performs the method of claim 1.

19. The processing device of claim 1, the processing device comprising a memory storing computer code that, when executed, the processing device performs the method of claim 1.
